(19) United States
(12) Patent Application Publication
(10) Pub. No.: US 2013/0204560 A1
(43) Pub. Date: Aug. 8, 2013

(54) Gas Gauge Device

(71) Applicants: Ying-Che Lo, Hsinchu City (TW); Ming-Hsien Lee, Hsinchu City (TW)

(72) Inventors: Ying-Che Lo, Hsinchu City (TW); Ming-Hsien Lee, Hsinchu City (TW)

(21) Appl. No.: 13/364,343

(22) Filed: Feb. 2, 2012

(51) Int. Cl. G06F 19/00

(52) U.S. Cl. 702/63

(57) ABSTRACT

The present invention discloses a gas gauge device for measuring a state of charge of a battery. The gas gauge device comprises a first programmable gain amplifier (PGA), for amplifying a battery current of the battery with a first adjustable gain, to generate an amplified battery current; a first analog to digital (ADC) converter, for converting the amplified battery current into a digital amplified battery current with a first adjustable sampling rate; and a micro controller, for adjusting the first adjustable gain and the first adjustable sampling rate to measure the battery current.

### BACKGROUND OF THE INVENTION

1. Field of the Invention

The present invention relates to a gas gauge device, and more particularly, to a gas gauge device capable of adjusting gains of programmable gain amplifiers (PGAs) and sampling rates of analog to digital (ADC) converters, to properly measure a battery current, a battery voltage and a battery temperature, to determine a state of charge of the battery.

2. Description of the Prior Art

Generally, a conventional gas gauge device determines a state of charge of a battery according to a current integration calibration table in a normal operation mode.

In detail, the current integration calibration table is established by measuring battery currents of other batteries in a same batch as the battery with different charge rates and temperatures. Therefore, in the normal operation mode, the conventional gas gauge device can measure a battery current and determine a corresponding state of charge in the current integration calibration table.

On the other hand, the current integration calibration table is established by measuring battery voltages of other batteries in the same batch as the battery with state of charges. Therefore, in a sleep mode, the conventional gas gauge device can measure a battery voltage, i.e. OCV, and determine a corresponding state of charge in the OCV calibration table.

However, an analog to digital (ADC) converter of the conventional gas gauge device can only measure a battery current, a battery voltage or a battery temperature in a fixed measurable range, and thus it is difficult for the conventional ADC converter to correctly measure the battery current, the battery voltage or the battery temperature with wide variation. Besides, the state of charge varies with different charge/discharge cycles, wherein a charge/discharge cycle is a cycle which a battery is fully charged and then discharged, and the conventional current integration calibration table and the conventional OCV calibration table can not be correctly applied in conditions of different charge/discharge cycles. Thus, there is a need for improvement over the prior art.

### SUMMARY OF THE INVENTION

It is therefore an objective of the present invention to provide a gas gauge device capable of adjusting gains of programmable gain amplifiers (PGAs) and sampling rates of analog to digital (ADC) converters, to properly measure a battery current, a battery voltage and a battery temperature, to determine a state of charge of the battery.

The present invention discloses a gas gauge device for measuring a state of charge of a battery. The gas gauge device comprises a first programmable gain amplifier (PGA), for amplifying a battery current of the battery with a first adjustable gain, to generate an amplified battery current ; a first analog to digital (ADC) converter, for converting the amplified battery current into a digital amplified battery current with a first adjustable sampling rate; and a micro controller, for adjusting the first adjustable gain and the first adjustable sampling rate to measure the battery current.

The present invention further discloses a state of charge determination method for a battery. The state of charge determination method includes amplifying a battery current of the battery with a first adjustable gain, to generate an amplified battery current; converting the amplified battery current into a digital amplified battery current with a first adjustable sampling rate; and adjusting the first adjustable gain and the first adjustable sampling rate to measure the battery current.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a gas gauge device according to an embodiment of the present invention.

FIG. 2A is a schematic diagram of a state of charge determination process according to an embodiment of the present invention.

FIG. 2B is a schematic diagram of a current integration calibration table corresponding to a specific charge/discharge cycle according to an embodiment of the present invention.

FIG. 3A is a schematic diagram of a state of charge determination process according to another embodiment of the present invention.

FIG. 3B is a schematic diagram of an open circuit voltage calibration table according to an embodiment of the present invention.

### DETAILED DESCRIPTION

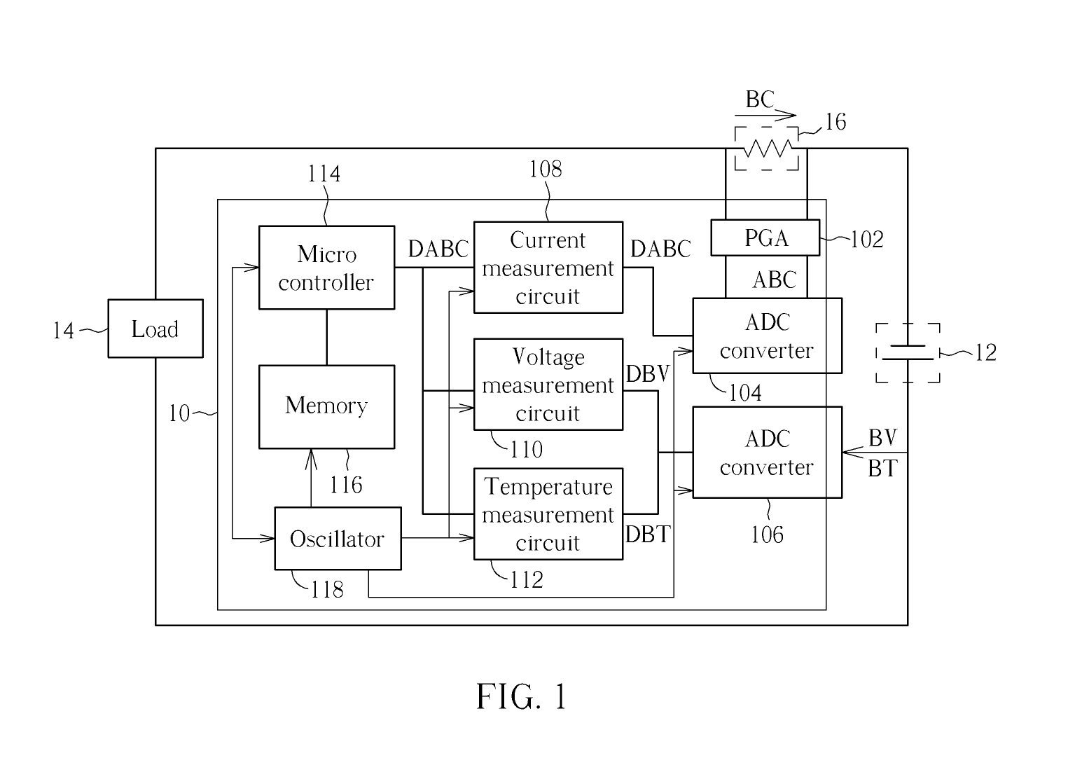

Please refer to FIG. 1, which is a schematic diagram of a gas gauge device 10 according to an embodiment of the present invention. As shown in FIG. 1, the gas gauge device 10 measures a battery current BC, a battery voltage BV and a battery temperature BT, to determine a state of charge of the battery 12, which can provide power to a load 14 and is coupled to a resistor 16 for providing the battery current BC to the gas gauge device 10. The gas gauge device 10 includes a programmable gain amplifier (PGA) 102, analog to digital (ADC) converters 104, 106, a current measurement circuit 108, a voltage measurement circuit 110, a temperature measurement circuit 112, a micro controller 114, a memory 116, and an oscillator 118.

In short, the PGA 102 amplifies the battery current BC of the battery 12 with an adjustable gain GN₁₀₂, to generate an amplified battery current ABC for the ADC converter 104. The ADC converter 104 converts the amplified battery current ABC into a digital amplified battery current DABC with an adjustable sampling rate SR₁₀₄, and the current measurement circuit 108 measures the digital amplified battery current DABC for the micro controller 114. The micro controller 114 adjusts the adjustable gain GN₁₀₂ and the adjustable sampling rate SR₁₀₄ to measure the battery current BC. As a result, the micro controller 114 can properly measure the battery current BC under different circumstances.

In detail, the micro controller 114 can adjust the adjustable sampling rate SR₁₀₄ according to a variation of the battery current BC. Under such a situation, if the load 14 is a consumer electronic products, which have steady currents, the micro controller 114 can lower the adjustable sampling rate SR₁₀₄ to reduce power consumption; if the load 14 is an electric motor or an electric bicycle, which may have large transient current, the micro controller 114 can increase the adjustable sampling rate SR₁₀₄ to correctly measure the battery current BC.

Besides, the micro controller 114 can also adjust the adjustable gain GN₁₀₂ according to whether the amplified battery current ABC is in a measurable range of the ADC converter 104. Under such a situation, if the amplified battery current ABC is lower than the measurable range of the ADC converter 104, i.e. the ADC converter 104 can not correctly convert the amplified battery current ABC into the digital amplified battery current DABC, the micro controller 114 can increase the adjustable gain GN₁₀₂ such that the amplified battery current ABC can be in the measurable range of the ADC converter 104; if the amplified battery current ABC is higher than the measurable range of the ADC converter 104, i.e. the ADC converter 104 can not correctly convert the amplified battery current ABC into the digital amplified battery current DABC, the micro controller 114 can lower the adjustable gain GN₁₀₂ such that the amplified battery current ABC can be in the measurable range of the ADC converter 104. As a result, the micro controller 114 can properly measure the battery current BC under different circumstances by adjusting the adjustable gain GN₁₀₂ and the adjustable sampling rate SR₁₀₄.

On the other hand, the ADC converter 106 converts the battery voltage BV and the battery temperature BT into a digital battery voltage DBV and a digital battery temperature DBT with a adjustable sampling rate SR₁₀₆, and the micro controller 114 can adjust the sampling rate SR₁₀₆ to measure the battery voltage BV and the battery temperature BT. Noticeably, the gas gauge device 10 can further include a PGA for amplifying the battery voltage BV with another adjustable gain for the ADC converter 106 (not shown), and the micro controller 114 adjusts the other adjustable gain to measure the battery voltage BV. Operations of the micro controller 114 adjusting adjustable sampling rate SR₁₀₆ and the other adjustable gain to properly measure the battery voltage BV and the battery temperature BT under different circumstances can be derived by referring to the above descriptions related to measure the battery current BC, and are not narrated hereinafter.

Besides, the oscillator 118 generates a system clock for components of the gas gauge device 10 such as the ADC converters 104, 106, the current measurement circuit 108, the voltage measurement circuit 110, the temperature measurement circuit 112, the micro controller 114 and the memory 116. The micro controller 114 can control the oscillator 118 to adjust the system clock according to the digital battery temperature DBT, and thus the micro controller 114 can adjust a time base for current integration according to temperature variation.

Therefore, since the micro controller 114 can properly and correctly measure the battery current BC, the battery voltage BV and the battery temperature BT under different circumstances, the micro controller 114 can operate in different modes to reduce power consumption and determine the state of charge of the battery 12 accordingly. For example, the micro controller 114 can operate under a normal operation mode, a sleep mode and a hibernate mode, which are a descending order of power consumption, and the memory 116 can store a current integration calibration table and an open circuit voltage (OCV) calibration table for the micro controller 114 to determine the state of charge of the battery 12 accordingly.

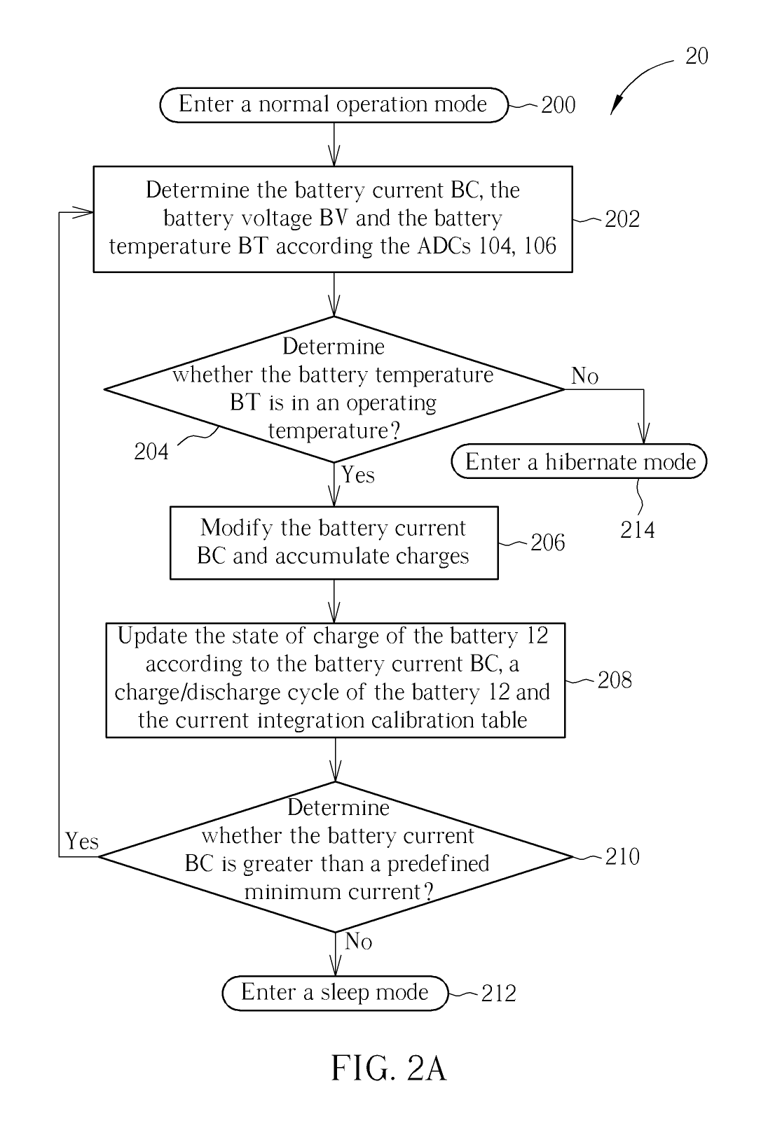

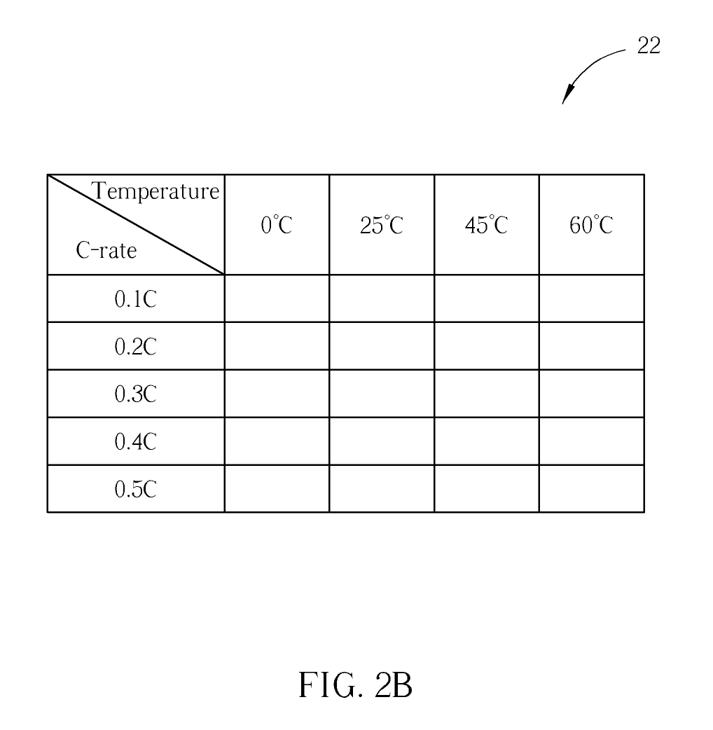

Under such a situation, please refer to FIG. 2A, which is a schematic diagram of a state of charge determination process 20 according to an embodiment of the present invention. The state of charge determination process 20 includes the following steps:

Step 200: Enter a normal operation mode.

Step 202: Determine the battery current BC, the battery voltage BV and the battery temperature BT according the ADCs 104, 106.

Step 204: Determine whether the battery temperature BT is in an operating temperature. If yes, go to step 206; otherwise, enter a hibernate mode.

Step 206: Modify the battery current BC and accumulate charges.

Step 208: Update the state of charge of the battery 12 according to the battery current BC, a charge/discharge cycle of the battery 12 and the current integration calibration table.

Step 210: Determine whether the battery current BC is greater than a predefined minimum current. If yes, go to step 202; otherwise, go to step 312.

Step 212: Enter a sleep mode.

Step 214: Enter a hibernate mode.

According to the state of charge determination process 20, the micro controller 114 operates in a normal operation mode if the battery current BC is greater than a predefined minimum current and the battery temperature BT is in an operating temperature, and determine the state of charge of the battery 12 according to the battery current BC, a charge/discharge cycle of the battery 12 and the current integration calibration table in the normal operation mode.

Specifically, please refer to FIG. 2B, which is a schematic diagram of a current integration calibration table 22 corresponding to a specific charge/discharge cycle according to an embodiment of the present invention, wherein one charge/discharge cycle is one cycle which a battery is fully charged and then fully discharged. The current integration calibration table 22 is established according to battery currents of other batteries in a same batch as the battery 12 with different charge rates, temperatures and the specific charge/discharge cycles, i.e. measuring battery currents of other batteries in the same batch in different conditions. Therefore, since a plurality of current integration calibration tables 22 corresponding to different charge/discharge cycles are stored in the memory 116, the micro controller 114 can determine the corresponding state of charge of the battery 12 in the current integration calibration table according to a corresponding charge/discharge cycle of the battery 12, i.e. how many cycles the battery 12 has been fully charged and then fully discharged, and the current integration calibration table. As a result, the micro controller 114 can determine the state of charge of the battery 12 according to the corresponding charge/discharge cycle of battery 12.

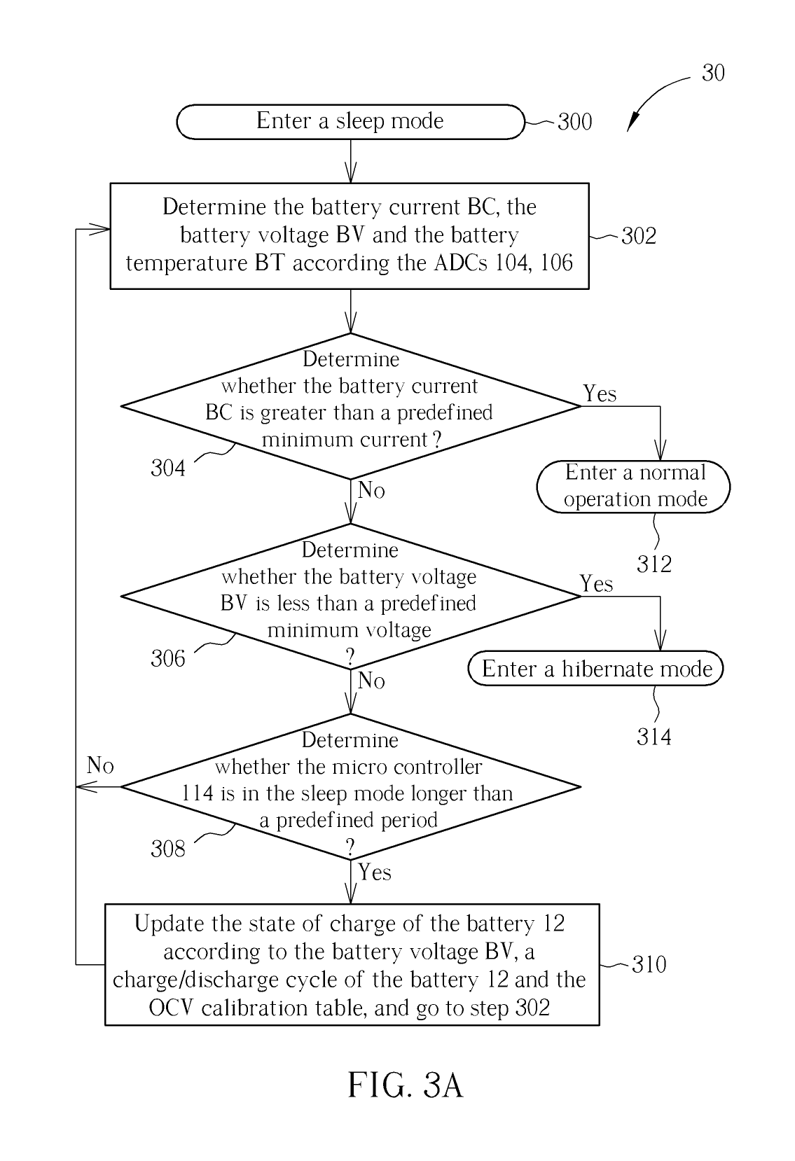

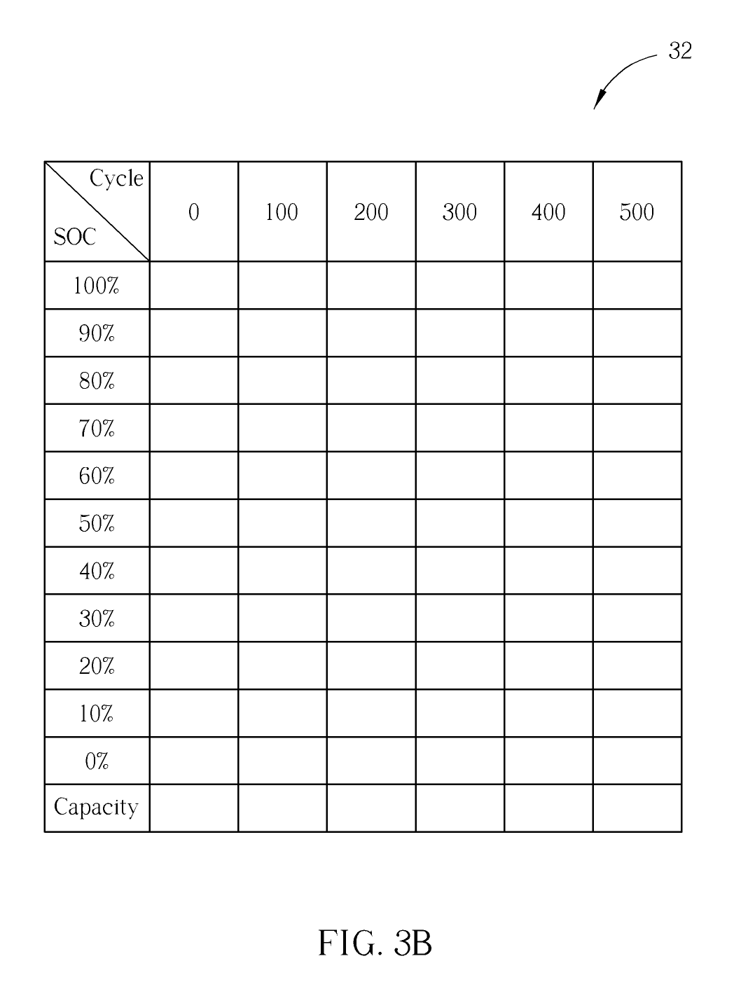

Under such a situation, please refer to FIG. 3A, which is a schematic diagram of a state of charge determination process 30 according to an embodiment of the present invention. The state of charge determination process 30 includes the following steps:

Step 300: Enter a sleep mode.

Step 302: Determine the battery current BC, the battery voltage BV and the battery temperature BT according the ADCs 104, 106.

Step 304: Determine whether the battery current BC is greater than a predefined minimum current. If yes, go to step 412; otherwise, go to step 306.

Step 306: Determine whether the battery voltage BV is less than a predefined minimum voltage. If yes, go to step 414; otherwise, go to step 308.

Step 308: Determine whether the micro controller 114 is in the sleep mode longer than a predefined period. If yes, go to step 410; otherwise, go to step 302.

Step 310: Update the state of charge of the battery 12 according to the battery voltage BV, a charge/discharge cycle of the battery 12 and the OCV calibration table, and go to step 302.

Step 312: Enter a normal operation mode.

Step 314: Enter a hibernate mode.

According to the state of charge determination process 30, the micro controller 114 operates in a sleep mode if the battery current BC is less than the predefined minimum current, and determine the state of charge of the battery 12 according to the battery voltage BV, a charge/discharge cycle of the battery 12 and the OCV calibration table if the battery current BC is less than a predefined minimum current, the battery voltage BV is less than a predefined minimum voltage and the micro controller 114 is in the sleep mode longer than a predefined period.

Specifically, please refer to FIG. 3B, which is a schematic diagram of an OCV calibration table 32 according to an embodiment of the present invention, wherein one charge/discharge cycle is one cycle which a battery is fully charged and then discharged. The OCV calibration table 32 is established according to OCVs of batteries in a same batch as the battery with different charge/discharge cycles and state of charges, i.e. measuring OCVs of other batteries in the same batch in different conditions. Therefore, since the OCV calibration tables 32 have OCVs corresponding to different charge/discharge cycles and states of charges are stored in the memory 116, the micro controller 114 can determine the corresponding state of charge of the battery 12 in the OCV calibration table according to the battery voltage BV and a corresponding charge/discharge cycle of battery 12, i.e. how many cycles the battery 12 has been fully charged and then fully discharged. As a result, the micro controller 114 can determine the state of charge of the battery 12 according to the charge/discharge cycle of battery 12.

Noticeably, the spirit of the present invention is to properly and correctly measure the battery current BC, the battery voltage BV and the battery temperature BT by adjusting gains of PGAs and sampling rates of ADC converters, so as to determine a state of charge of the battery under different circumstances. Those skilled in the art should make modifications or alterations accordingly. For example, the current integration calibration table and the OCV calibration table stored in the memory 116 may not correspond to all charge/discharge cycles, and thus the micro controller 114 can perform interpolation to determine the state of charge of the battery 12. Besides, since the charge/discharge cycle of the battery 12 is required for the micro controller 114 to determine the corresponding state of charge of the battery 12 in the current integration calibration table or the OCV calibration table, the micro controller 114 needs to know the charge/discharge cycle of the battery 12.

In the prior art, the conventional ADC converter of the conventional gas gauge device can only measure a battery current, a battery voltage or a battery temperature in a fixed measurable range, and thus it is difficult for the conventional ADC converter to correctly measure the battery current, the battery voltage or the battery temperature with wide variations. Besides, the state of charge varies with different charge/discharge cycles, and the conventional current integration calibration table and the conventional OCV calibration table can not be correctly applied in conditions of different charge/discharge cycles. In comparison, the present invention can properly and correctly measure the battery current BC, the battery voltage BV and the battery temperature BT by adjusting gains of PGAs and sampling rates of ADC converters, so as to determine the state of charge of the battery according to the current integration calibration table and the OCV calibration table corresponding to different charge/discharge cycles.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gas gauge device for determining a state of charge of a battery, comprising:
a first programmable gain amplifier (PGA), for amplifying a battery current of the battery with a first adjustable gain, to generate an amplified battery current;
a first analog to digital (ADC) converter, for converting the amplified battery current into a digital amplified battery current with a first adjustable sampling rate; and
a micro controller, for adjusting the first adjustable gain and the first adjustable sampling rate to measure the battery current.

2. The gas gauge device of claim 1, wherein the micro controller adjusts the first adjustable sampling rate according to a variation of the battery current.

3. The gas gauge device of claim 1, wherein the micro controller adjusts the first adjustable gain according to whether the amplified battery current is in a measurable range of the first ADC converter.

4. The gas gauge device of claim 1, wherein the micro controller operates in a normal operation mode if the battery current is greater than a predefined minimum current.

5. The gas gauge device of claim 1 further comprising a memory, for storing a current integration calibration table, and the micro controller determines the state of charge according to the battery current, a corresponding charge/discharge cycle of the battery and the current integration calibration table in a normal operation mode.

6. The gas gauge device of claim 5, wherein the current integration calibration table is established according to battery currents of other batteries in a same batch as the battery with different charge rates, temperatures and charge/discharge cycles.

7. The gas gauge device of claim 1 further comprising a second ADC converter, for converting a battery voltage and a battery temperature into a digital battery voltage and a digital battery temperature with a second adjustable sampling rate, and the micro controller adjusts the second sampling rate to measure the battery voltage and the battery temperature.

8. The gas gauge device of claim 6 further comprising a second PGA, for amplifying the battery voltage with a second adjustable gain for the second ADC converter, and the micro controller adjusts the adjustable gain to measure the battery voltage.

9. The gas gauge device of claim 7, wherein the micro controller operates in a sleep mode if the battery current is less than a predefined minimum current.

10. The gas gauge device of claim 7 further comprising a memory, for storing an open circuit voltage (OCV) calibration table, and the micro controller determines the state of charge according to the battery voltage, a corresponding charge/discharge cycle of the battery and the OCV calibration table if the battery current is less than a predefined minimum current, the battery voltage is less than a predefined minimum voltage and the micro controller is in a sleep mode longer than a predefined period.

11. The gas gauge device of claim 9, wherein the OCV calibration table is established according to OCVs of batteries in a same batch as the battery with different charge/discharge cycles and state of charges.

12. The gas gauge device of claim 7 further comprising an oscillator for generating a system clock, wherein the micro controller controls the oscillator to adjust the system clock according to the digital battery temperature.

13. A state of charge determination method for a battery, comprising:
amplifying a battery current of the battery with a first adjustable gain, to generate an amplified battery current;
converting the amplified battery current into a digital amplified battery current with a first adjustable sampling rate; and
adjusting the first adjustable gain and the first adjustable sampling rate to measure the battery current.

14. The state of charge determination method of claim 13, wherein the step of adjusting the first adjustable gain and the first adjustable sampling rate to measure the battery current comprises:
adjusting the first adjustable sampling rate according to a variation of the battery current.

15. The state of charge determination method of claim 13, wherein the step of adjusting the first adjustable gain and the first adjustable sampling rate to measure the battery current comprises:
adjusting the first adjustable gain according to whether the amplified battery current is in a measurable range.

16. The state of charge determination method of claim 13 further comprising:
operating in a normal operation mode if the battery current is greater than a predefined minimum current.

17. The state of charge determination method of claim 13 further comprising:
storing a current integration calibration table; and
determining the state of charge according to the battery current, a corresponding charge/discharge cycle of the battery and the current integration calibration table in a normal operation mode.

18. The state of charge determination method of claim 17, wherein the current integration calibration table is established according to battery currents of other batteries in a same batch as the battery with different charge rates, temperatures and charge/discharge cycles.

19. The state of charge determination method of claim 13 further comprising:
converting a battery voltage and a battery temperature into a digital battery voltage and a digital battery temperature with a second adjustable sampling rate; and
adjusting the second sampling rate to measure the battery voltage and the battery temperature.

20. The state of charge determination method of claim 18 further comprising:
amplifying the battery voltage with a second adjustable gain for the second ADC converter; and
adjusting the adjustable gain to measure the battery voltage.

21. The state of charge determination method of claim 19 further comprising:
operating in a sleep mode if the battery current is less than a predefined minimum current.

22. The state of charge determination method of claim 19 further comprising:
storing an open circuit voltage (OCV) calibration table; and
determining the state of charge according to the battery voltage, a corresponding charge/discharge cycle of the battery and the OCV calibration table if the battery current is less than a predefined minimum current, the battery voltage is less than a predefined minimum voltage and the micro controller is in a sleep mode longer than a predefined period.

23. The state of charge determination method of claim 21 further comprising:
establishing the OCV calibration table according to OCVs of batteries in a same batch as the battery with different charge/discharge cycles and state of charges.

24. The state of charge determination method of claim 19 further comprising:
adjusting a system clock according to the digital battery temperature.
